(19) United States
(12) Patent Application Publication
(10) Pub. No.: US 2012/0138525 A1
(43) Pub. Date: Jun. 7, 2012

(54) IONIZATION WATER TREATMENT APPARATUS USING CARBON NANOTUBE

(75) Inventors: Tai Hyun JO, Jeonju-si (KR); Yong Ki KWON, Jeonju-si (KR)

(73) Assignee: IOREX CO., LTD, Jeonju-si (KR)

(21) Appl. No.: 13/304,640

(22) Filed: Nov. 26, 2011

(30) Foreign Application Priority Data
Dec. 1, 2010 (KR) 10-2010-0121141

(51) Int. Cl. B01D 39/20; C02F 1/00; B01D 35/00; B82Y 30/00

(52) U.S. Cl. 210/446; 977/778

(57) ABSTRACT

Disclosed is an ionization water treatment apparatus using a carbon nanotube. In the ionization water treatment apparatus, water flowing through the tubular body is ionized and activated due to the potential difference, and a filter is constructed in such a manner that the water makes contact with the carbon nanotube to perform an antibacterial function and a function of adsorbing heavy metal, so that the structure thereof is simplified, a superior antibacterial effect and superior ionization performance are represented, and rust is prevented in a tubular body due to the removal of foreign matters. The filtering member is constructed in such a manner that the contact area between the water passing through the tubular body and a filter is maximized, so that efficiency is more increased in an antibacterial function and in the removal of foreign matters when water passes through a filtering member.

### BACKGROUND OF THE INVENTION

1. Field of the Invention

The present invention relates to an ionization water treatment apparatus using a carbon nanotube. In more particular, the present invention relates to an ionization water treatment apparatus using a carbon nanotube, in which water is ionized and activated due to the potential difference caused by the flow rate of the water flowing through a tubular body, thereby preventing rust, scale, and slime from being produced in the tubular body, removing the rust, the scale, and the slime from the tubular body, and adsorbing heavy metal with an antibacterial function.

2. Description of the Related Art

In general, in tubular bodies, such as water and sewage pipes and feed/drain pipes of a boiler or a water purifier, used to supply water, oxygen free radicals contained in the supplied water frequently react with metallic components contained in the pipe so that the inner part of the pipe may be corroded. The corrosion of the pipe causes rust to an inner peripheral surface of the pipe and thus the flow of the water is interrupted by the rust. Since the water flowing through the pipe contains various substances such as oxidized steel, foreign matters, and germs harmful to the human body, the water is insanitary.

In order to solve the above problem, the inner part of the tubular body is periodically cleaned or is replaced with new one after a predetermined period elapses. However, much time and manpower are required for the cleaning and the replacement work for the tubular body.

As one of schemes to solve the above problems, an ionization water treatment apparatus has been developed and used. The ionization water treatment apparatus is disclosed in both of Korean Patent Registration No. 10-0312152 and Korean Patent Registration No. 10-0862970.

According to the ionization water treatment apparatus disclosed in Korean Patent Registration No. 10-0312152, water passing through a tubular body is ionized due to an electrostatic field, so that the water is activated as finely decomposed water molecules, thereby not only purifying the water, but also cleaning the inner part of the tubular body.

The ionization water treatment apparatus includes a static electricity generating rod formed by sequentially arranging a carbon rod, a copper rod, and a carbon rod at a predetermined interval inside a first pipe, a static electricity generating tube formed by sequentially arranging a carbon tube, a copper tube, and a carbon tube on an outer peripheral portion of a second pipe, an insulating tube blocking the transfer of internal and external temperatures, a finishing element preventing water from inflowing between the static electricity generating tube and the insulating tube, a housing which has the insulating tube and the finishing element inserted therein and is provided at the central portion thereof with a grounding part grounded with the copper tube of the static electricity generating tube, and a housing connection member screwed with both outer peripheral surfaces of the housing and provided therein with a support part to support the static electricity generating rod.

Meanwhile, Korean Patent Registration No. 10-0862970 discloses a carbon electrode for ionization water treatment capable of representing the superior heavy metal removing rate, a method for manufacturing the same, and an ionization water treatment apparatus including the carbon electrode. The ionization water treatment apparatus includes an static electricity generating element to generate an electrostatic field, an insulating tube having the static electricity generating element inserted therein and blocking the transfer of the internal and external temperatures, a finishing element to prevent water from inflowing into the insulating tube, a housing having the insulating tube and the finishing element inserted therein, and a housing connection member having one side coupled with the housing and an opposite side coupled with the tubular body. The static electricity generating element includes a metallic electrode, two carbon electrodes provided at both sides of the metallic electrode, and a pipe having the carbon electrode and the metallic electrode assembled therein.

However, the ionization water treatment apparatus according to the related art has the following problems.

1) An element of generating an electrostatic field is essentially required in order to ionize water. However, the element causes the whole structure of the ionization water treatment apparatus to be complicated.

2) Since the ionization degree varies depending on the intensity of the electrostatic field, a high-price electrode is required to form the electrostatic field. Accordingly, the manufacturing cost is increased, and the difficulty is made when manufacturing the ionization water treatment apparatus.

3) The intensity of the electrostatic field must be increased in order to increase the ionization degree. Accordingly, the ionization degree may be degraded as compared with another ionization water treatment apparatus having the same size.
Reference 1: Shankar Ghosh et al, “Carbon Nanotube Flow Sensors”, SCIENCE, Vol 299, pp. 1042-1044, 2003, FEBRUARY.
Reference 2: “new dangerousness of carbon nanotube: adsorption of heavy metal by forming colloid”, ┌Global Trends Briefing (GTB)┘, KISTI, 2009-05-10, (http://www.sciencedaily.com/releases/2009/05/090504121921.htm).
Reference 3: “water-absorbing pavement for eco-cooling effectively using soil of filtration plant”, ┌Global Trends Briefing (GTB)┘, KISTI, 2008-05-07.
Reference 4:

(http://radar.ndsl.kr/tre_View.do?cn=GTB2008050154&ct=TREND&l p=SI).

### SUMMARY OF THE INVENTION

Accordingly, the present invention has been made keeping in mind the above problems occurring in the prior art, and an object of the present invention is to provide an ionization water treatment apparatus using a carbon nanotube, in which water flowing through a tubular body is ionized and activated due to the potential difference, and a filter is constructed in such a manner that the water makes contact with the carbon nanotube to perform an antibacterial function and a function of adsorbing heavy metal, thereby preventing rust, scale, and slime from being produced in the tubular body, removing the rust, the scale, and the slime from the tubular body, and adsorbing heavy metal with an antibacterial function in a simple structure.

Another object of the present invention is to provide an ionization water treatment apparatus using a carbon nanotube, in which the filtering member is constructed in such a manner that the contact area between the water passing through the tubular body and a filter can be maximized, thereby more increasing efficiency in an antibacterial function and in the removal of foreign matters when water passes through a filtering member.

To accomplish these objects, according to a first embodiment of the present invention, there is provided an ionization water treatment apparatus using a carbon nanotube, which includes a housing prepared in a cylindrical shape and having both end portions detachably equipped with caps having an inlet part and an outlet part, respectively, and a plurality of reaction rods provided between the caps. The surface of each reaction rod is coated with a carbon nanotube coating layer.

In addition, according to a second embodiment of the present invention, there is provided an ionization water treatment apparatus using a carbon nanotube, which includes a housing prepared in a cylindrical shape and having both end portions detachably equipped with caps having an inlet part and an outlet part, respectively, and a filtering member provided between the caps and installed in the housing while being spaced apart from the caps by a predetermined distance. The filtering member is formed therein with a plurality of guide passages extending lengthwise along the filtering member, and a carbon nanotube coating layer is formed on each inner peripheral surface of each guide passage.

Especially, the carbon nanotube coating layer is coated by using a single wall carbon nanotube. In addition, the carbon nanotube coating layer is coated through a cold spraying coating scheme, a thermal spraying coating scheme, or an attachment scheme using a binder.

In addition, the housing includes copper or stainless steel.

Meanwhile, according to a third embodiment of the present invention, there is provided an ionization water treatment apparatus using a carbon nanotube, which includes a housing prepared in a cylindrical shape and having both end portions detachably equipped with caps having an inlet part and an outlet part, respectively, and a filtering member provided between the caps and installed in the housing while being spaced apart from the caps. The filtering member is formed by depositing the carbon nanotube on one surface of a base through a predetermined deposition scheme.

In addition, the deposition scheme may include a thermal decomposition scheme, a laser ablation scheme, a plasma chemical vapor deposition scheme, a thermal vapor deposition scheme, or a catalytic chemical vapor deposition scheme.

As described above, the ionization water treatment apparatus using the carbon nanotube has following effects.

1) As water passing through the tubular body by the carbon nanotube causes potential difference due to the flow rate of the water, and the water is ionized due to the potential difference, rust, scale, and slime are prevented from being produced in the tubular body and removed from the tubular body.

2) The ionization water treatment apparatus using the carbon nanotube can be simplified in the whole structure and represent superior performance by constructing a filter using the carbon nanotube generally known as a material having an antibacterial effect, adsorbing heavy metal, and activating water.

3) Since the carbon nanotube can be grown (through a chemical vapor deposition scheme) or coated regardless of the shape of a filter or a filtering member, the carbon nanotube can be manufactured suitably to the capacity of the filter regardless of the size of the ionization water treatment apparatus using the carbon nanotube.

### BRIEF DESCRIPTION OF THE DRAWINGS

The above and other objects, features and other advantages of the present invention will be more clearly understood from the following detailed description when taken in conjunction with the accompanying drawings, in which:

FIG. 1A is an exploded perspective view showing the whole structure of an ionization water treatment apparatus using a carbon nanotube according to a first embodiment of the present invention;

FIG. 1B is a sectional view showing the assembling state of the ionization water treatment apparatus using the carbon nanotube according to the first embodiment of the present invention;

FIG. 2A is an exploded perspective view showing the whole structure of an ionization water treatment apparatus using a carbon nanotube according to a second embodiment of the present invention;

FIG. 2B is a sectional view showing the assembling state of the ionization water treatment apparatus using the carbon nanotube according to the second embodiment of the present invention;

FIG. 3A is an exploded perspective view showing the whole structure of an ionization water treatment apparatus using a carbon nanotube according to a third embodiment of the present invention; and

FIG. 3B is a sectional view showing the assembling state of the ionization water treatment apparatus using the carbon nanotube according to the third embodiment of the present invention.

### DETAILED DESCRIPTION OF THE INVENTION

Hereinafter, exemplary embodiments of the present invention will be described in detail with reference to accompanying drawings. Prior to the description of the present invention, terminologies and words used in the specification and accompanying claims are not limited to the meanings introduced in a dictionary, but should be comprehended as meanings and concepts suitable for the technical spirits and scope of the present invention under the principle that the subject inventor can define new coin words the most suitable for the invention of the subject inventor.

Accordingly, components and structures disclosed in embodiments and accompanying drawings of the present specification are used for illustrative purposes, and do not represent all technical spirits and scope of the present invention. Accordingly, those skilled in the art should comprehend that there may be various equivalents and modifications substituted for the embodiments at a time point at which the present invention is filed.

### Embodiment 1

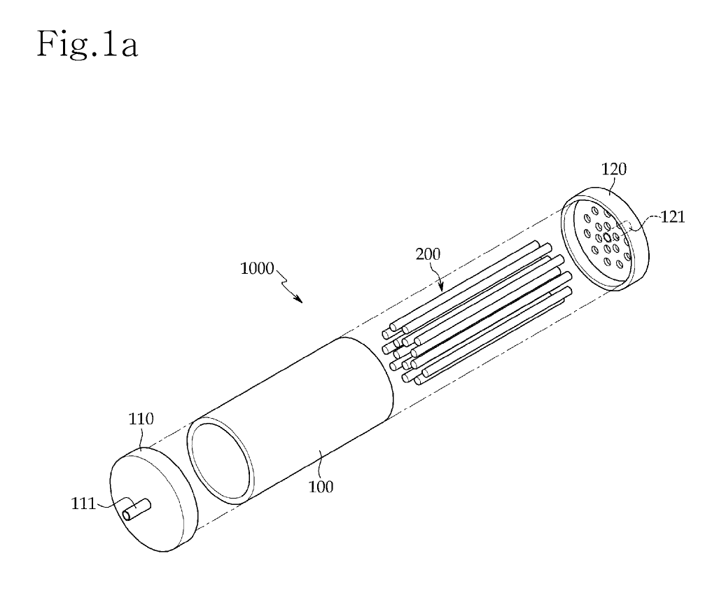

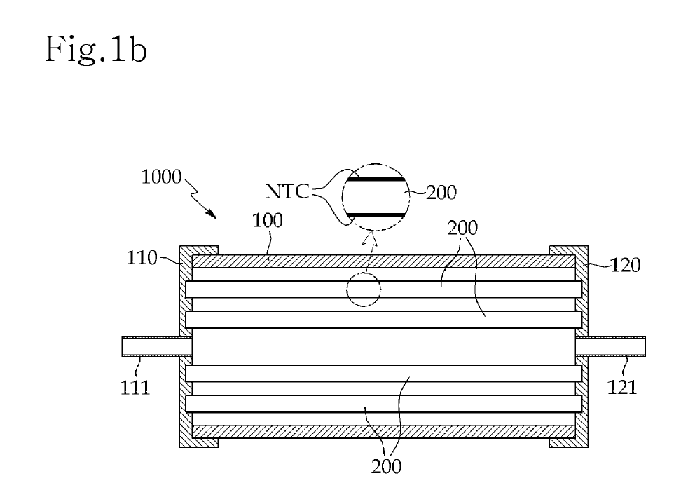

FIG. 1A is an exploded perspective view showing the whole structure of an ionization water treatment apparatus 1000 using a carbon nanotube according to a first embodiment of the present invention, and FIG. 1B is a sectional view showing the assembling state of the ionization water treatment apparatus 1000 using the carbon nanotube according to the first embodiment of the present invention.

The ionization water treatment apparatus 1000 using the carbon nanotube according to the first embodiment of the present invention includes a housing 100 sealed to the extent that water can flow therethrough, and reaction rods 200 installed in the housing 100. In particular, carbon nanotube coating layers (NTC) are coated on the reaction rods 200 so that the water can be subject to the antibacterial treatment, the heavy metal can be adsorbed, and the water can be activated.

Hereinafter, the above components will be described in more detail.

The housing 100 has the shape of a cylinder having a predetermined thickness and is provided at both ends thereof with caps 110 and 120. The caps 110 and 120 are provided therein with an inlet 111 and an outlet 121 allowing the inflow and the outflow of the water, respectively.

Preferably, the housing 100 includes a copper tube or a stainless tube, so that a coating layer can be easily coated on the surface of the housing 100 by using the carbon nanotube.

The reaction rods 200 are installed between a pair of the caps 110 and 120. In this case, the reaction rods 200 are fixedly fitted into one of the caps 110 and 120 in parallel to each other. As the caps 110 and 120 are mounted on the housing 100, end portions of the reaction rods 200 are fixedly fitted into the other cap.

In particular, a coating layer is formed on each reaction rod 200 by using a carbon nanotube generally known as a material having an antibacterial effect, representing the superior adsorbability of the heavy metal and ionizing water by activating the water. In this case, preferably, the carbon nanotube used for the carbon nanotube coating layer (NTC) includes SWNT, thereby more improving the antibacterial effect. In addition, the NTC may be formed through a cold spraying coating scheme, a thermal spraying coating scheme, or an attachment scheme using a binder generally known as a conventional technology.

The coated carbon nanotube causes the potential difference due to the flow rate of water passing through a tubular body (see reference 1), and the water is ionized into positive ions H⁺ and negative ions OH⁻ due to the potential difference. The activation of the water according to the ionization not only prevents rust, scale, and slime from being produced in the tubular body, but also removes the rust, scale, and the slime from the tubular body. In addition, the surface structure of the carbon nanotube is deformed in the water to form a colloid solution to increase the adsorbability with the heavy metal (see reference 2). If the carbon nanotube is especially the SWNT, the carbon nanotube represents the high rate (99.999%) of removing bacteria, and deactivates bacteria while being maintained in a complete form (see reference 3).

Therefore, the ionization water treatment apparatus 1000 using the carbon nanotube according to the present invention not only can activate the water due to the potential difference caused by the flow rate of the water, but can adsorb heavy metal with the antibacterial function.

### Embodiment 2

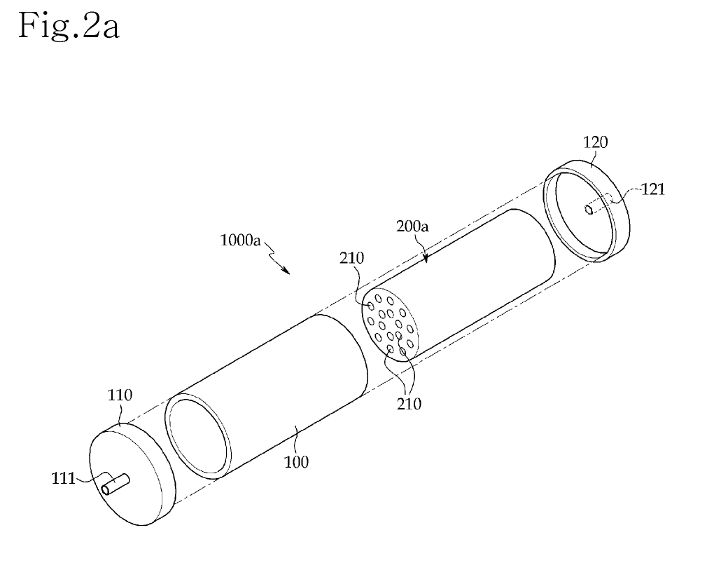

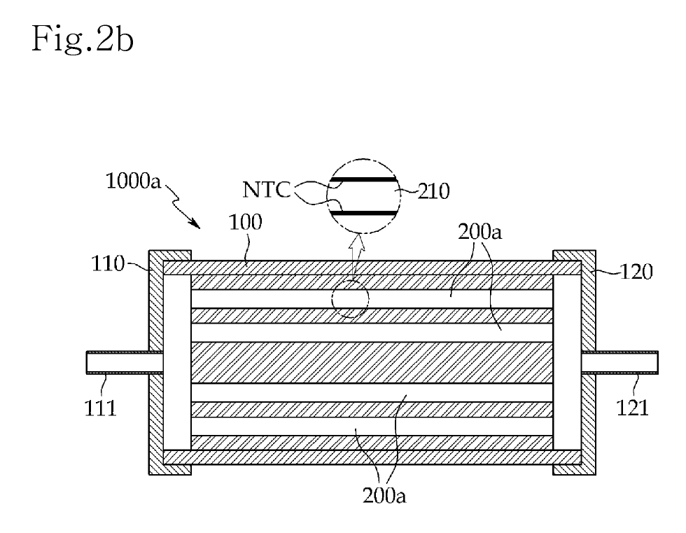

FIG. 2A is an exploded perspective view showing the whole structure of an ionization water treatment apparatus 1000a using a carbon nanotube according to a second embodiment of the present invention, and FIG. 2B is a sectional view showing the assembling state of the ionization water treatment apparatus 1000a using the carbon nanotube according to the second embodiment of the present invention. Hereinafter, the ionization water treatment apparatus 1000a using the carbon nanotube according to the second embodiment of the present invention will be described while focusing on the difference from the ionization water treatment apparatus 1000 using the carbon nanotube according to the first embodiment of the present invention.

When comparing with the ionization water treatment apparatus 1000 using the carbon nanotube according to the first embodiment of the present invention, the ionization water treatment apparatus 1000a using the carbon nanotube according to the second embodiment of the present invention makes a difference in a filtering unit. In other words, although the first embodiment employs the reaction rods 200 coated with the NTC, the second embodiment employs a filtering member 200a. However, the housing 100 has the same structure in the first and second embodiments.

The filtering member 200a has the shape of a cylinder, so that the filtering member 200a can be fitted into the housing 100. In this case, the filtering member 200a has a length shorter than that of the housing 100. Accordingly, the water introduced into the housing 100 is not stopped by the filtering member 200a, but can easily flow.

In particular, the filtering member 200a is formed therein with a plurality of guide passages 210 extending throughout the whole length of the filtering member 200a. In addition, the NTC is coated on an inner peripheral surface of each guide passage 210. Since the NTC is formed in the same manner as that of the first embodiment, the details of the NTC will be omitted in order to avoid redundancy.

### Embodiment 3

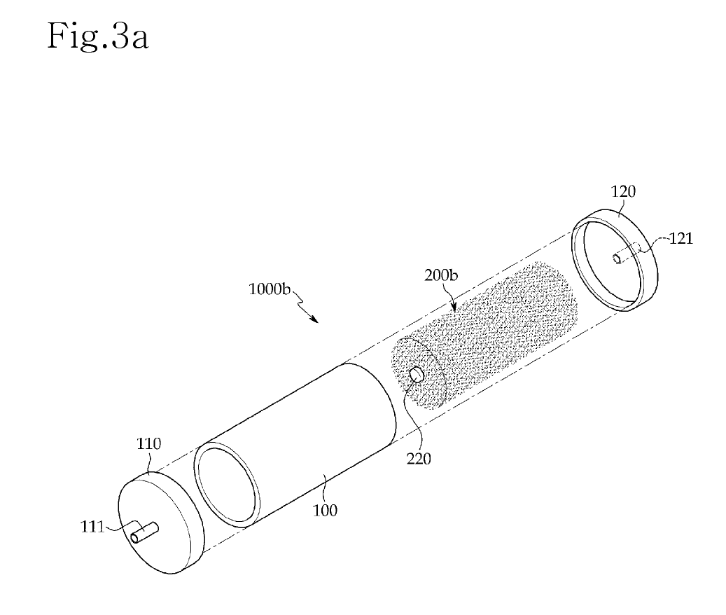

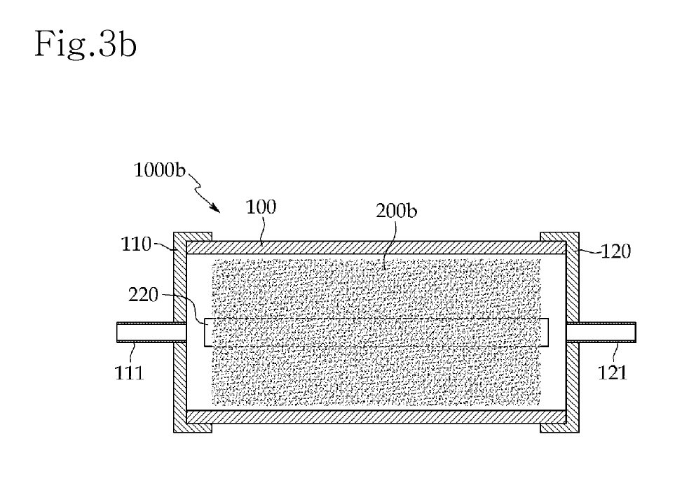

FIG. 3A is an exploded perspective view showing the whole structure of an ionization water treatment apparatus 1000b using a carbon nanotube according to a third embodiment of the present invention, and FIG. 3B is a sectional view showing the assembling state of the ionization water treatment apparatus 1000b using the carbon nanotube according to the third embodiment of the present invention.

The ionization water treatment apparatus 1000b using the carbon nanotube according to the third embodiment of the present invention includes the housing 100 and a filtering member 200b installed in the housing 100. In this case, since the housing 100 has the same structure as that of the second embodiment, the details thereof will be omitted in order to avoid redundancy.

The filtering member 200b is manufactured through an evaporation scheme. In this case, the adaptable evaporation schemes for the carbon nanotube include a thermal decomposition scheme, a laser ablation scheme, a plasma chemical vapor deposition (CVD) scheme, a thermal vapor deposition scheme, and a catalytic chemical vapor deposition scheme.

Preferably, the growth and the deposition of the carbon nanotube can be stably achieved through the CVD scheme among the above schemes.

To this end, in order to deposit the carbon nanotube, a base 220 is prepared. The carbon nanotube is deposited about the base 220. Then, carbon nanotube is deposited on the surface of the base 220 through the CVD by easily adjusting the growth length of the carbon nanotube or the growth degree of the carbon nanotube. Therefore, the carbon nanotube is deposited to the extent that the filtering member 200b has a size to be fitted into the housing 100.

As described above, the ionization water treatment apparatus using the carbon nanotube according to the present invention is manufactured by using the carbon nanotube capable of representing a superior antibacterial function, the superior adsorbability of the heavy metal, and a superior function of removing rust resulting from the activation of the water. Accordingly, the ionization water treatment apparatus using the carbon nanotube can be easily manufactured in a simple structure and desirable various shapes.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An ionization water treatment apparatus using a carbon nanotube, the ionization water treatment apparatus comprising:
a housing prepared in a cylindrical shape and having both end portions detachably equipped with caps having an inlet part and an outlet part, respectively; and
a filtering member provided between the caps and installed in the housing while being spaced apart from the caps by a predetermined distance,
wherein the filtering member is formed therein with a plurality of guide passages extending lengthwise along the filtering member, and a carbon nanotube coating layer is formed on each inner peripheral surface of each guide passage.

2. The ionization water treatment apparatus of claim 1, wherein the carbon nanotube coating layer is coated by using a single wall carbon nanotube (SWNT).

3. The ionization water treatment apparatus of claim 2, wherein the carbon nanotube coating layer is coated through a cold spraying coating scheme, a thermal spraying coating scheme, or an attachment scheme using a binder.

4. An ionization water treatment apparatus using a carbon nanotube, the ionization water treatment apparatus comprising:
a housing prepared in a cylindrical shape and having both end portions detachably equipped with caps having an inlet part and an outlet part, respectively; and
a filtering member provided between the caps and installed in the housing while being spaced apart from the caps,
wherein the filtering member is formed by depositing the carbon nanotube on one surface of a base through a predetermined deposition scheme.

5. The ionization water treatment apparatus of claim 4, wherein the deposition scheme includes a thermal decomposition scheme, a laser ablation scheme, a plasma chemical vapor deposition scheme, a thermal vapor deposition scheme, or a catalytic chemical vapor deposition scheme.
